(19) United States
(12) Patent Application Publication
(10) Pub. No.: US 2017/0028893 A1
(43) Pub. Date: Feb. 2, 2017

(54) Apparatus for Securing a Transit Seat

(71) Applicant: Kustom Seating Unlimited, Inc., Bellwood, IL (US)

(72) Inventor: William John Luebke, Aurora, IL (US)

(21) Appl. No.: 15/223,276

(22) Filed: Jul. 29, 2016

Related U.S. Application Data
(60) Provisional application No. 62/199,730, filed on Jul. 31, 2015.

(51) Int. Cl. B60N 2/68; B60N 2/24

(52) U.S. Cl. CPC B60N 2/682; B60N 2/242

(57) ABSTRACT

A device for locking a seat pan to a seat frame includes a housing, a latch, and a securing member. The housing is adapted to be secured to the seat pan. The latch includes a substantially planar portion and a shaped portion. The securing member secures the latch in the housing such that the latch is moveable between a resting position and a compressed position. The latch is adapted to move to the compressed position when the seat is urged into the seat frame, and, if urged further, to return to the resting position to entrap the cross member between the shaped portion and the seat pan.

### CROSS REFERENCE TO RELATED APPLICATIONS

The present application claims benefit of Luebke, U.S. Provisional Application No. 62/199,730, titled “Apparatus for Securing a Transit Seat,” and filed on Jul. 31, 2015. The entire contents of this application are incorporated herein by reference.

### FIELD OF DISCLOSURE

The present subject matter relates to a transit seat and more particularly, to an apparatus for securing a seat to the frame of the transit seat.

### BACKGROUND

A transit car may include one or more passenger seats. Typically, the passenger seat includes a frame that is secured to a floor and/or a wall of the transit car, and one or more seat cushions disposed on such frame. The seat cushions may be removable to provide access to parts of the passenger seat or transit car blocked by such components. The seat cushions also may be removable so that they may be cleaned, repaired, or otherwise maintained. If the transit car abruptly decelerates, for example, because of an accident, if the seat cushion is not securely locked in the seat frame, such seat cushion may unintentionally become disengaged from the seat frame.

### SUMMARY

According to one aspect, a device for locking a seat pan to a seat frame includes a housing, a latch, and a securing member. The housing is adapted to be secured to the seat pan. The latch includes a substantially planar portion and a shaped portion. The securing member secures the latch in the housing such that the latch is moveable between a resting position and a compressed position. The latch is adapted to move to the compressed position when the seat is urged into the seat frame, and, if urged further, to return to the resting position to entrap the cross member between the shaped portion and the seat pan.

According to another aspect, a kit of parts for securing a seat pan to a seat frame includes a housing adapted to be secured to the seat pan, a latch having a substantially planar portion and a shaped portion, a torsion spring, and a securing member. The securing member is adapted to secure the latch and torsion spring in the housing so that the latch is moveable between a resting position and a compressed position, and moving the latch to the compressed position causes compression of the torsion spring.

### BRIEF DESCRIPTION OF THE DRAWINGS

FIG. 1 is an isometric view of a passenger seat;

FIG. 2 is front elevation view a seat frame of the passenger seat of FIG. 1;

FIG. 3 is a side elevation view of the seat frame of the passenger seat of FIG. 1;

FIG. 4 is top plan view of a seat cushion frame of the passenger seat of FIG. 1;

FIG. 5 is a top plan view of a seat bottom of the passenger seat of FIG. 1, with portions removed;

FIG. 6 is a bottom plan view of the seat bottom of FIG. 5;

FIG. 7 is a front elevation view of the seat bottom of FIG. 5, with portions removed;

FIG. 8 is a cross-sectional view taken along the line 8-8 of FIG. 7 of the seat bottom of FIG. 5;

FIG. 9 is an isometric view of a locking device that may be used with passenger seat of FIG. 1;

FIG. 10 is a side elevation view of the locking device of FIG. 9;

FIG. 11 is front plan view of the locking device of FIG. 9;

FIG. 12 is an isometric view of a housing of the locking device of FIG. 9;

FIG. 13 is a top plan view of the locking device of FIG. 9;

FIG. 14 is an isometric view of a side plate of the locking device of FIG. 9;

FIG. 15 is an isometric view of a latch of the locking device of FIG. 9;

FIG. 16 is a rear elevation view of the latch of FIG. 15;

FIG. 17 is a side elevation view of the latch of FIG. 15;

FIG. 18 is a front plan view of the latch of FIG. 15;

FIG. 19 is a cross-sectional view taken along the line 19-19 of FIG. 15 of the latch of 15;

FIGS. 20 and 21 are side elevation views of alternate embodiments of the latch of FIG. 15; and

FIGS. 22-24 illustrate the use of the locking device of FIG. 9 with the passenger seat of FIG. 1.

### DETAILED DESCRIPTION

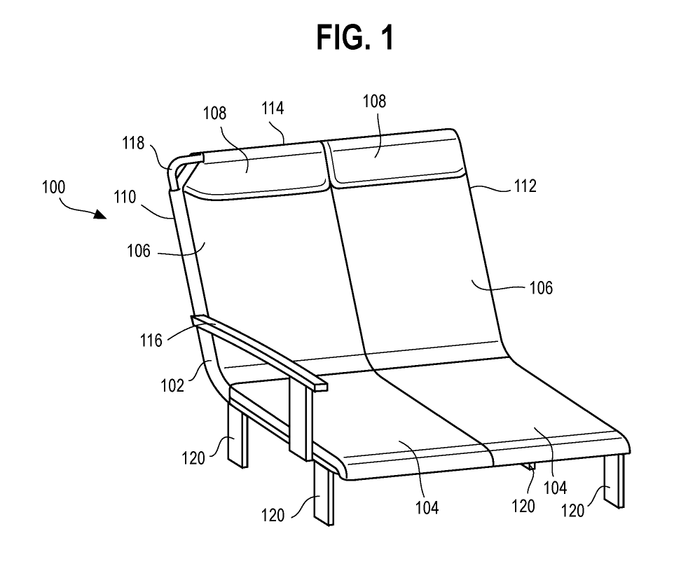

Referring to FIG. 1, a passenger seat 100 may be disposed in a transit vehicle such as a train, a bus, an airplane, and the like. Such passenger seat 100 may, for example, include a seat frame 102 on which a seat bottom 104, a seatback cushion 106, and a headrest 108 may be disposed. In some embodiments, the passenger seat 100 may accommodate multiple passengers and include a separate seatback cushion 106 and/or headrest 108 for each passenger the passenger seat 100 can accommodate. In other embodiments, even if the passenger seat 100 accommodates multiple passengers, the passenger seat 100 includes one seatback cushion 106 and one headrest 108, each of which spans the length of the passenger seat 100 between a first side 110 and a second side 112 of the passenger seat 100. In some embodiments, the passenger seat 100 may not include a headrest 108, and the seatback cushion 106 may extend to a top side 114 of the passenger seat 100.

The passenger seat 100 may be configured so that the first side 110 of the passenger seat 100 is disposed adjacent an aisle of the transit car, and the second side 112 of the passenger seat 100 is disposed adjacent a wall of the transit car. Alternately, the passenger seat 100 may be configured so that both the first side 110 and the second side 112 are disposed adjacent aisles of the transit car. In some embodiments, if the first side 110 or the second side 112 is disposed adjacent a wall, a portion of the seat frame 102 proximate such side 110 or 112 may be secured to the wall.

One or more armrests 116 may be secured to the seat frame 102. In some embodiments, one or more armrests 116 may be provided only on the first side 110 and/or the second side 112 of the passenger seat 100 that is adjacent an aisle. In other, embodiments, an armrest 116 is provided on each of the first side 110 and the second side 112. In some cases, an armrest 116 may be provided for each passenger that the seat can accommodate. Other configurations of the one or more armrests 116 will be apparent to those who have ordinary skill in the art.

A handle 118 may be secured to the seat frame 102 proximate the first side 110 and/or the second side 112 of the seat that is adjacent an aisle. A passenger traversing through the transit car may grasp the handle 118 for support.

The seat frame 102 may be secured to one or more legs 120, and the legs 120 may be secured to a floor of the transit car.

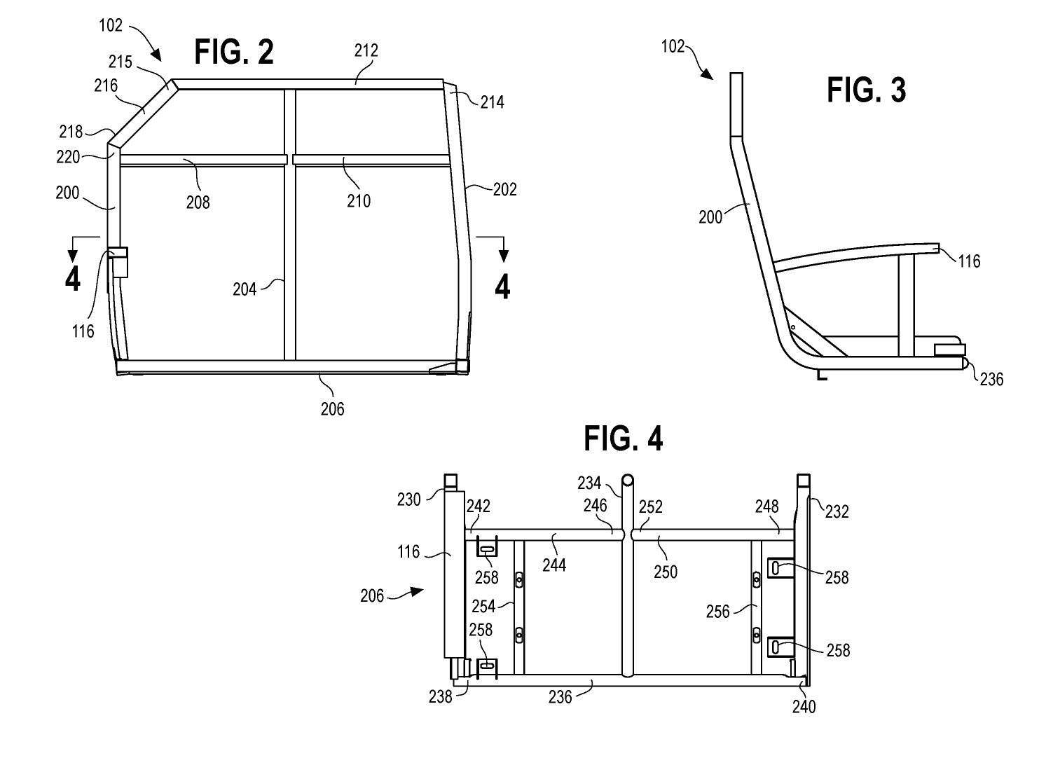

Referring to FIGS. 2-4, in one embodiment, the seat frame 102 may include a first side member 200, a second side member 202, a central member 204, and a seat cushion frame 206. A first cross member 208 may, for example, be coupled to the first side member 200 and the central member 204. A second cross member 210 may be secured to the second side member 202 and the central member 204. A top member 212 may be secured to a top portion 214 of the second side member 202. In some embodiments, the top member 212 may also be secured to one end 215 of a handle member 216, and a second end 218 of the handle member 216 may be secured to a top end 220 of the first side member 200. The handle 118 may be secured to the handle member 216.

If the passenger seat 100 is configured without a handle 118, the top member 212 may be secured directly to the top end 220 of the first side member 200 without any handle member 216 therebetween.

The seatback cushion 106 may be secured to the first and second side members 200 and 202, and the first and second cross members 208 and 210. In some embodiments, the passenger seat 100 may not include a headrest 108, and the seatback cushion 106 may also be secured to the top member 212. In other embodiments, the passenger seat 100 may include a headrest 108 that is secured to the first and second cross members 208 and 210, and the top member 212.

The first side member 200, second side member 202, the central member 204, the first cross member 208, the second cross member 210, the top member 212, and the handle member 216 may be manufactured from aluminum, die cast aluminum or magnesium, steel, fiberglass, or any durable material apparent to those who have ordinary skill in the art. Further, these members may be solid beams, hollow or solid circular or oval tubes, hollow or solid rectangular or square tubes, hollow or solid triangular tubes, hollow or solid polygonal tubes, or a combination thereof.

As illustrated in FIG. 3, in one embodiment, the first and second side members 200 and 202 may be a single piece formed to generally follow the contour of the passenger seat 100. It should be apparent to those who have skill in the art, that the first and/or second side member 200 and/or 202, respectively, may comprise one or more separate components joined together to form a piece that generally follows the contour of the passenger seat 100.

The seat cushion frame 206, FIG. 4, may include a first side member 230, a second side member 232, and a central member 234. The seat cushion frame 206 may also include a front cross member 236 that substantially spans a distance between the first side member 230 and the second side member 232. In particular, a first end 238 of the front cross member 236 may be secured to the first side member 230, and a second end 240 of the front cross member 236 may secured to the second side member 232.

The seat cushion frame 206 may also include a first rear cross member 242. A first end 244 of the first rear cross member 242 is secured to the first side member 230 and a second end 246 of the first rear cross member 242 is secured to the central member 234. A first end 248 of a second rear cross member 250 is secured to the second side member 232, and a second end 252 of the second rear cross member 250 is secured to the central member 234. In combination the first rear cross member 242 and the second rear cross member 250, for example, may substantially span the distance between the first side member 230 and the second side member 232 of the seat cushion frame 206.

The seat cushion frame 206 also may include a first transverse member 254 secured to the front cross member 236 and to the first rear cross member 242. In some embodiments, the first transverse member 254 may be disposed so that it is substantially perpendicular to the front cross member 236 and the first rear cross member 244. A second transverse member 256 may be secured to the front cross member 236 and the second rear cross member 250, and may be disposed to be perpendicular to the front cross member 236 and the second rear cross member 250.

The first side member 230, second side member 232, the central member 234, the front cross member 236, the first rear cross member 242, the second rear cross member 250, the first transverse member 254, and the second transverse member 256 that comprise the seat cushion frame 206 may be manufactured from aluminum, steel, fiberglass, or any durable material apparent to those who have ordinary skill in the art. Further, these members may be these members may be solid beams, hollow or solid circular or oval tubes, hollow or solid rectangular or square tubes, hollow or solid triangular tubes, hollow or solid polygonal tubes, or a combination thereof.

In some embodiments, the front cross member 236, the first rear cross member 244, and the second side member 232 may include one or more leg joint portions 258, and a leg 120 may be secured to each such leg joint portion 258. It will be apparent to those who have ordinary skill in the art that such leg joints portions 258 may be disposed on other parts of the seat cushion frame 206.

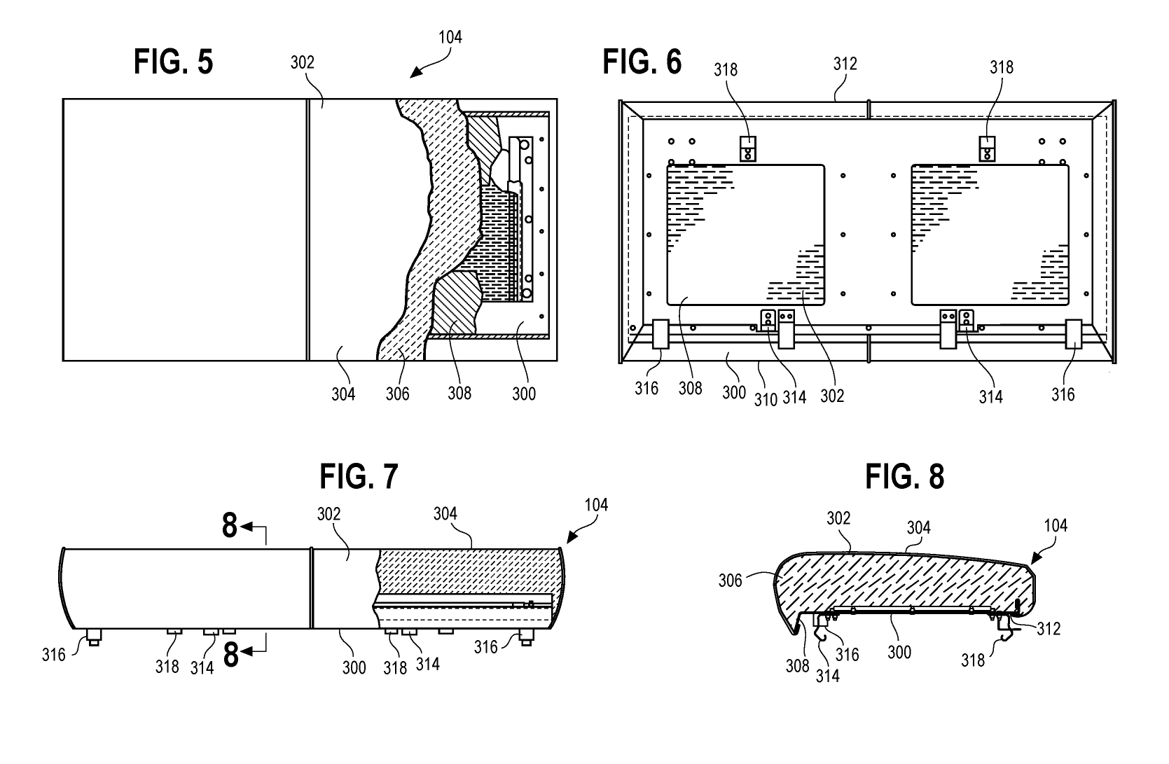

Referring to FIGS. 5-8, the seat bottom 104 includes a seat pan 300 to which a seat cushion 302 may be secured. In some embodiments, the seat bottom 104 may include a separate seat cushion 302 secured to the seat pan 300 for each passenger the seat bottom 104 is designed to accommodate. In other embodiments, the seat bottom 104 may include one seat cushion 302 spanning the length thereof regardless of the number passengers the seat bottom 104 may accommodate. In some embodiments, the seat cushion 302 may include a top cover 304, a foam insert 306, and a bottom cover 308. Typically, the top cover 304 and bottom cover 308 are sewn or otherwise secured to one another to enclose the foam insert 306 therebetween.

The seat pan 300 may be constructed from aluminum, steel, fiberglass, or any durable material apparent to those who have ordinary skill in the art. The seat pan 300, in this example, has a front portion 310 and a rear portion 312. One or more front hook members 314 and locking devices 316 may be secured to the seat pan 300 proximate the front portion 310 thereof, and one or more rear hook members 318 may be secured to the seat pan 300 proximate the rear portion 312 thereof. Such hook members 314 and 318, and locking devices 316, may bolted, screwed, or riveted to the seat pan 300. Other ways of securing such members and devices to the seat pan 300 may be used that are apparent to those who have ordinary skill in the art.

Referring to FIGS. 9-14, the locking device 316, in this example, includes a housing 350 that includes sidewalls 352 and 354 coupled to a top wall 356. The sidewalls 352 and 354 and the top wall 356 may be integrally formed from a single piece of metal (or other suitable material), or may be formed by attaching separate pieces to one another, for example, by welding or bonding. Each sidewall 352 and 354 of the housing 350 includes an orifice 358. Disposed in the housing 350 are a latch 360 and a torsion spring 362.

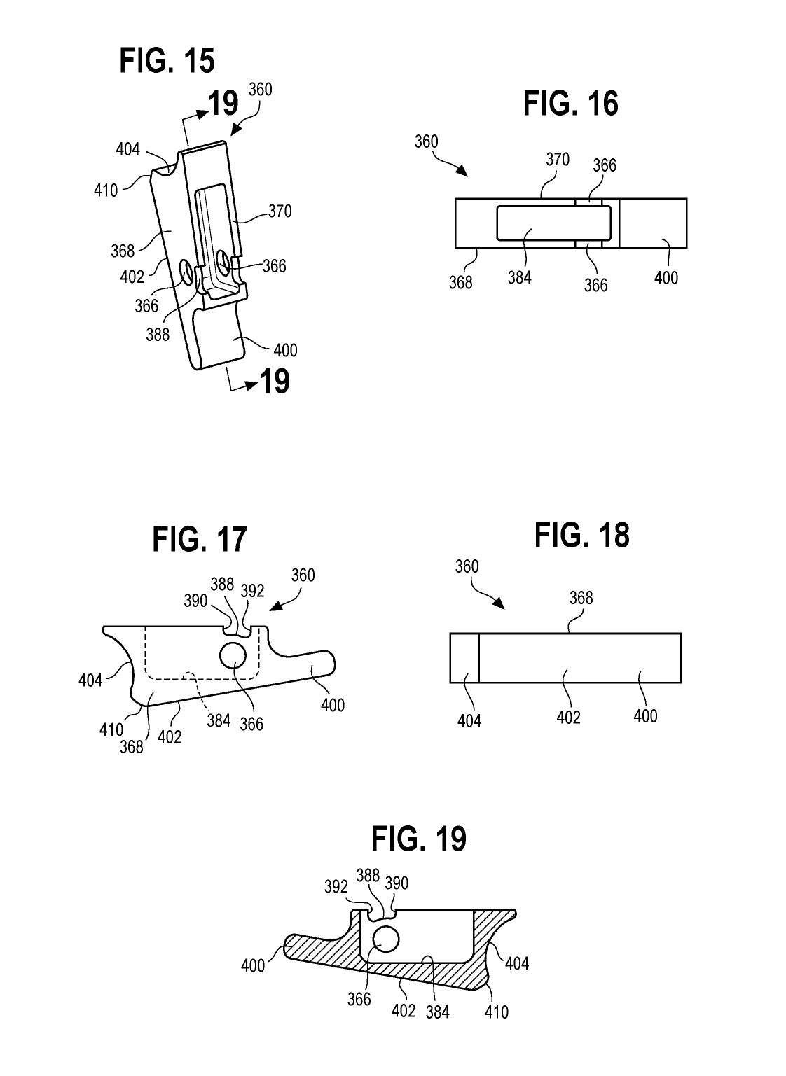

Referring also to FIGS. 15-19, a bolt 364 is passed through the orifice 358 in the sidewall 352 of the housing 350, through an orifice 366 in a first sidewall 368 of the latch 360, through the center of the torsion spring 362, through an orifice 366 in a second sidewall 370 of the latch 360, and through the orifice 358 in the sidewall 354 of the housing 350. In one embodiment, a clevis pin 372 locks the bolt 364 in place. A retaining ring, cotter pin, or push nut may hold the clevis pin 372. Other ways of locking the bolt 364 in place may be used instead of the clevis pin 372 including, for example, a shoulder bolt with a nut on the end, or a thrust bearing with a through bolt and nut.

A stop plate 374 is secured to each of the sidewalls 352 and 354, and in this example, includes a ledge portion 376 having a notch portion 378. The torsion spring 362 is disposed in the housing 350 such that one free end 380 of the torsion spring 362 rests in the notch portion 378 of ledge portion 376 of the stop plate 374, and another free end 382 of the torsion spring abuts an inside surface 384 of the latch 360.

A stop pin 386 is passed through in an orifice 387 in the sidewall 352 of the housing 350. The stop pin 386 contacts a guide 388 formed in the first sidewall 368 of the latch 360. The guide 388 spans a distance between a first stop position 390 and a second stop position 392.

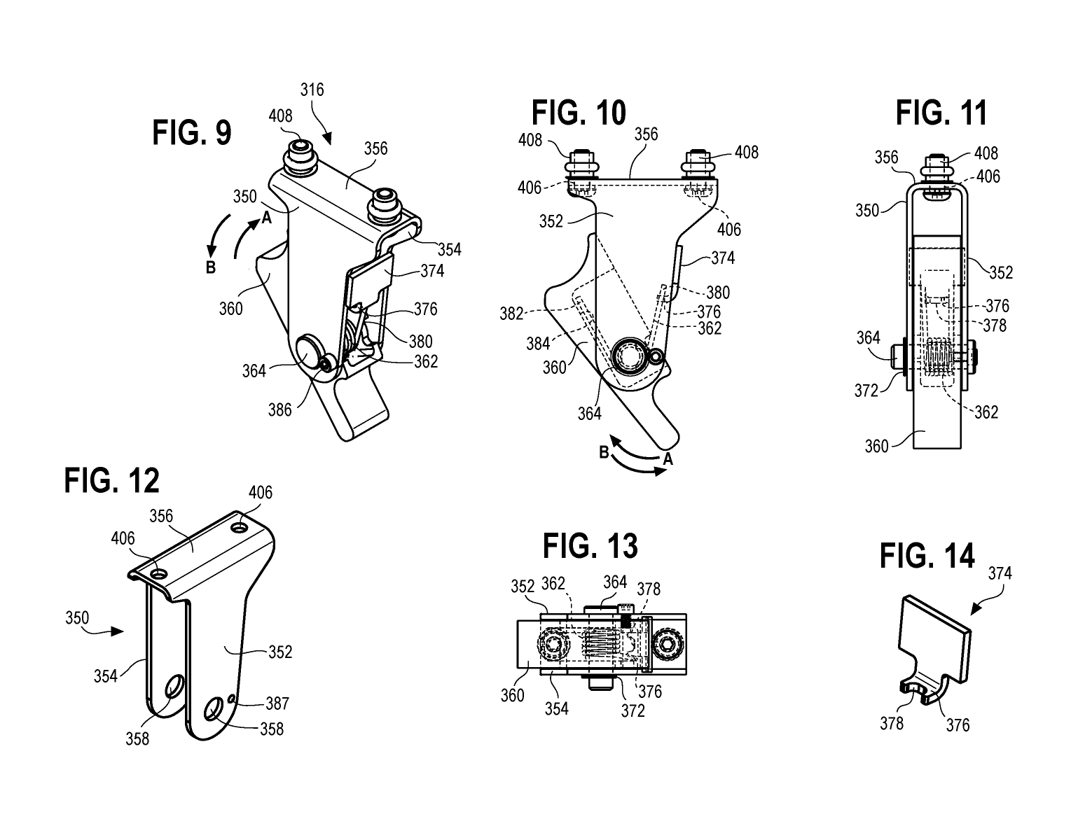

As described above and shown, the latch 360 has a resting position in which the torsion spring 362 is decompressed and the stop pin 386 contacts the first stop position 390. When a force is applied to the latch 360 to urge the latch 360 to rotate about the central axis of the bolt 364 along the direction of arrow A (FIG. 10) to move to the compressed position. Such movement of the latch 360 also causes the torsion spring 362 to compress. The latch 360 may be moved in this manner until second stop position 392 of the latch 360 contacts the stop pin 386. Thereafter, if the force to the latch 360 is removed, the torsion spring 362 decompresses and causes the latch 360 to move about the central axis of the bolt 364 in a direction noted by arrow B (FIG. 10), until the latch 360 returns to the resting position.

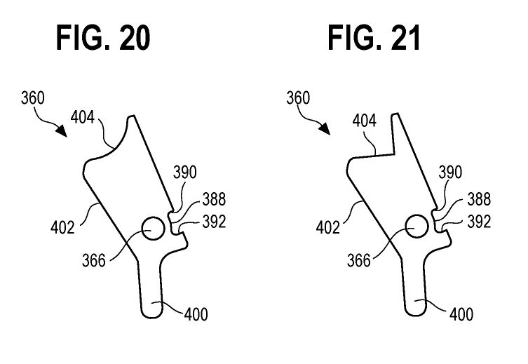

The latch 360 includes a handle 400 and a substantially planar front wall 402. In some embodiments the handle 400 may be a linear extension of the planar front wall 402 as shown in FIGS. 15-19. In other embodiments, the handle 400 may be angularly offset from the planar front wall 402 as shown FIGS. 20-21. The planar front wall 402 extends to a shaped portion 404, which in some embodiments may be arcuate as shown in FIGS. 9-20. In other embodiments, the shaped portion 404 may be angular as shown in FIG. 21. As will become apparent below, the profile of the shaped portion 404, whether arcuate, angular, or otherwise, may be selected to conform to the profile of the front cross member 236 (see FIG. 4) of the seat cushion frame 206.

In one embodiment, the housing 350 of the locking device 316 may include one or more orifices 406. Screws or bolts 408 may be passed through the orifices 406 and corresponding orifices in the seat pan 300 to secure the locking device 316 to the seat pan 300. Alternately, the locking device 316 may be riveted, welded, or bonded to the seat pan 300.

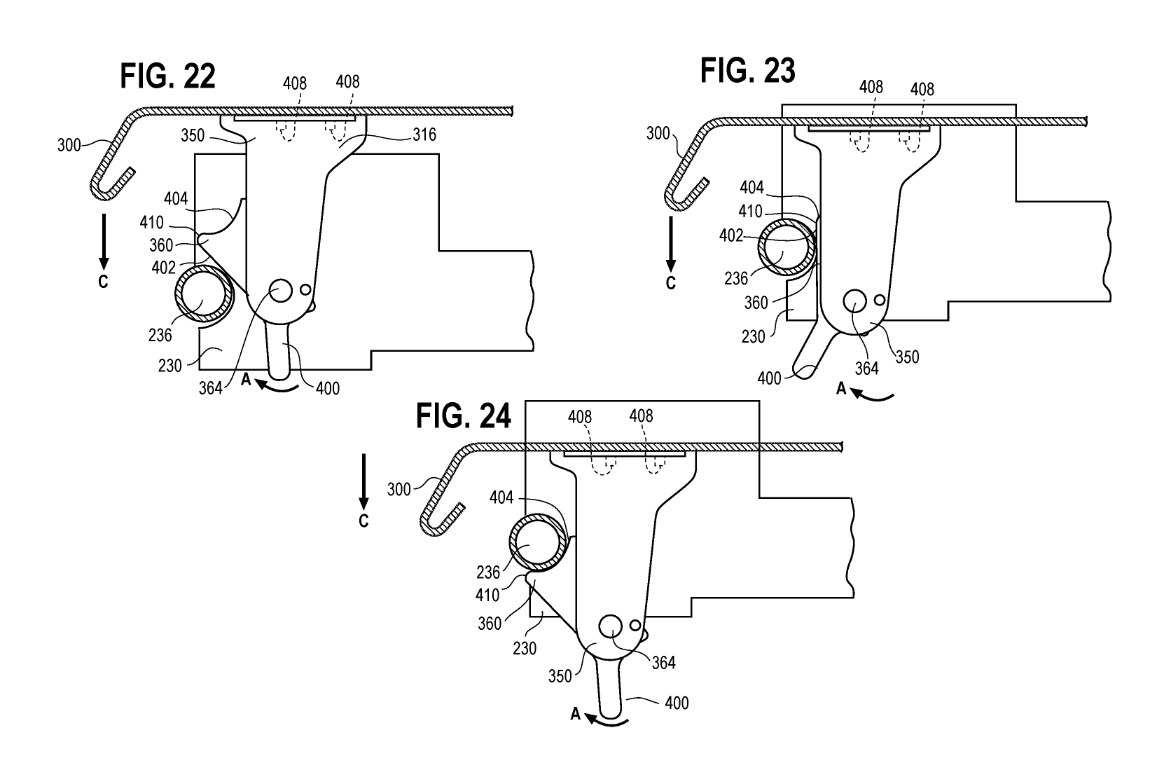

Referring to FIGS. 22-24, to secure the seat bottom 104 to the seat frame 102, the seat pan 300 of the seat bottom 104, with the locking device 316 attached thereto, is disposed on the seat cushion frame 206 such that the front cross member 236 contacts the planar face 402 of the latch 360 (see FIG. 22). Pushing the seat pan 300 downward (i.e., in the direction indicated by the arrow C) causes front cross member 236 to slide along the planar front wall 402 of the latch 360. The downward force is transferred via the front cross member 236 to the latch 360, and such force causes the latch 360 to rotate about the bolt 364 and move from the resting position to the compressed position. As described above, such movement of the latch 360 simultaneously compresses the torsion spring 362 (see FIG. 13). If the seat pan 300 is continued to be pushed downward, the front cross member 236 continues to slide along the planar front wall 402 until the front cross member 236 reaches an end 410 of the planar front wall 402. If additional force is applied to urge the seat pan 300 downward after the front cross member 236 reaches the end 410 of the planar front wall 402, such downward force is no longer transferred to the latch 360 and the torsion spring 362 decompresses, which causes the latch 360 to return the resting position (see FIG. 24). When the latch 360 returns to the resting position, the front cross member 236 is disposed between the seat pan 300 and the shaped portion 404 of the latch 360. Further, the front cross member 236 is entrapped by the shaped portion 404 of latch 360 such that shaped portion 404 of the latch 360 prevents the seat pan 300 from being pulled upward (in a direction opposite the arrow C) or from being released from the seat cushion frame 206.

In some embodiments, when the latch 360 returns to the resting position, the torsion spring 362 decompresses sufficiently rapid so that the first stop position 390 strikes the stop pin 386 with sufficient force that an audible sound or click is made. Such audible sound indicates to an operator that the seat pan 300 is securely locked into the seat cushion frame 206. When the latch 360 returns to the resting position, the shaped portion 404 may also strike the cross member 236 with sufficient fore to produce an audible sound that indicates that the seat pan 300 is securely locked into the seat cushion frame 206.

If the seat frame 102 of the passenger seat 100 is secured in a transit car facing the direction of motion, and the seat bottom 104 is secured to the seat cushion frame 206 with the locking device 316 as described above, a sudden deceleration of the transit car may exert a forward force on the passenger seat 100. However, in such situations, the locking device 316 may prevent the seat bottom 104 from separating from the seat cushion frame 206, because, at least, the shaped portion 404 of the latch 360 encompasses the front cross member 236 and thus prevents the seat bottom 104 to move away from the front cross member 236. Further, such deceleration may thrust the sidewalls 352 and 354 of the housing 350 against the front cross member 236 to further prevent the seat bottom 104 from separating from the front cross member 236.

The seat pan 300 may be manually released from the seat cushion frame 206, by pushing downward on the seat pan 300 and simultaneously rotating the handle 400 of the latch 360 about the bolt 364 in the direction shown by arrow A. Such rotation causes the latch 360 to move from the resting position into the compressed position. After the latch 360 is moved into the compressed position, the seat pan 300 may be lifted further (in the direction opposite of the arrow C) so that front cross member 236 of the seat pan contacts and slides along the planar front wall 402 of the latch 360. The seat pan 300 may be lifted in this manner until the seat pan 300 is removed from the seat cushion frame 206.

The locking device 316 may be adapted for use with different types of seats by adjusting, and indeed may be provided as a retrofit to existing passenger seats 100. For example, the shaped portion 404 of the latch 360 may be adapted to conform to the front cross member 236 of the seat cushion frame, as described above. The location of the orifices 406 and/or the way the housing 350 may also be adapted to secure the locking device 316 to an existing the seat pan 300. Other modifications to adapt the locking device 316 for use with existing passenger seats 100 will be apparent to those who have skill in the art.

The locking device 316 may be supplied as a kit of parts that includes one or more of the housing 350 with the stop plate 374 secured thereto, the latch 360, the torsion spring 362, the bolt 364, the clevis pin 372, and hardware to secure to housing 350 to the seat pan 300 of the passenger seat 100. The locking device 316 may be assembled in situ with parts in the kit and commonly available parts (if necessary) and secured to the seat pan 300 as described above.

### INDUSTRIAL APPLICABILITY

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the disclosure (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

What is claimed is:

1. A device for locking a seat pan to a seat frame, wherein the seat frame includes a cross member, the device comprising:
a housing adapted to be secured to the seat pan;
a latch, wherein the latch includes a substantially planar portion and a shaped portion; and
a securing member that secures the latch in the housing such that the latch is moveable between a resting position and a compressed position;
wherein the latch is adapted to move to the compressed position when the seat is urged into the seat frame, and, if urged further, to return to the resting position to entrap the cross member between the shaped portion and the seat pan.

2. The device of claim 1, further including a torsion spring, wherein the securing member secures the torsion spring in the housing.

3. The device of claim 2, wherein the housing includes a first sidewall and a second sidewall, a stop plate secured to the first sidewall and the second sidewall, wherein a first end of the torsion spring abuts the stop plate.

4. The device of claim 3, wherein a second end of the torsion spring abuts the latch.

6. The device of claim 3, wherein rotation of the latch causes the compression of the torsion spring.

7. The device of claim 1, wherein applying a force to the planar portion when the latch in the resting position causes the latch to rotate about a central axis of the securing member and thereby compress to the compress position.

8. The device of claim 1, wherein the latch includes a handle, and moving the handle causes the shaped portion to release the cross member.

9. The device of claim 1, wherein the shaped portion is arcuate.

10. The device of claim 1, wherein the shaped portion is angular.

11. The device of claim 1, wherein the further urging causes the torsion spring to release and move the latch to the resting position.

12. The device of claim 1, wherein the securing member includes a bolt and a clevis pin.

13. A kit of parts for securing a seat pan to a seat frame, the kit including:
a housing adapted to be secured to the seat pan;
a latch having a substantially planar portion and a shaped portion;
a torsion spring; and
a securing member;
wherein, the securing member is adapted to secure the latch and torsion spring in the housing so that the latch is moveable between a resting position and a compressed position, and moving the latch to the compressed position causes compression of the torsion spring.

14. The kit of claim 13, wherein the shaped portion is arcuate.

15. The kit of claim 13, wherein the shaped portion is angular.

16. The kit of claim 13, wherein the securing member comprises a bolt and a clevis pin.

17. The kit of claim 13, wherein the housing includes a stop plate, and the torsion spring includes a first end and a second end, wherein the securing member is adapted to secure the torsion spring and the latch in the housing so that the first end abuts the stop plate and the second end abuts the latch.

18. The kit of claim 13, wherein when shaped portion is adapted to entrap a cross member of the seat frame between the shaped portion and the seat pan.

19. The kit of claim 13, wherein when the kit is assembled, the latch may be moved between a resting position and a compressed position by applying a force to the substantially planar portion.
